(19) United States
(12) Patent Application Publication
(10) Pub. No.: US 2006/0017813 A1
(43) Pub. Date: Jan. 26, 2006

(54) Image pick-up apparatus and image restoration method

(76) Inventors: Mitsumasa Okubo, Hino-shi (JP); Masaki Higurashi, Hachioji-shi (JP); Masashi Hankawa, Hachioji-shi (JP); Yuji Imai, Hachioji-shi (JP)

Correspondence Address: STRAUB & POKOTYLO, 620 TINTON AVENUE, BLDG. B, 2ND FLOOR, TINTON FALLS, NJ, 07724, US

(21) Appl. No.: 11/183,644

(22) Filed: Jul. 18, 2005

(30) Foreign Application Priority Data
Jul. 21, 2004 (JP) 2004-213579

(51) Int. Cl. H04N 5/228

(52) U.S. Cl. 348/208.2; 348/208.6

(57) ABSTRACT

An image pick-up apparatus includes an optical system which forms a subject image. An image pick-up unit obtains image data from the subject image formed by the optical system. A vibration detecting unit detects a vibration of the image pick-up apparatus. In an image deterioration information storage unit, information of image deterioration generated by the optical system is stored. An image deterioration correcting unit corrects the image deterioration generated by the optical system with respect to the image data output from the image pick-up unit in accordance with the image deterioration information stored in the image deterioration information storage unit. A vibration restoring unit restores the image deteriorated by the vibration with respect to the image data output from the image deterioration correcting unit in accordance with the vibration detecting signal of the time series.

### CROSS-REFERENCE TO RELATED APPLICATIONS

This application is based upon and claims the benefit of priority from prior Japanese Patent Application No. 2004-213579, filed Jul. 21, 2004, the entire contents of which are incorporated herein by reference.

### BACKGROUND OF THE INVENTION

1. Field of the Invention

The present invention relates to an image pick-up apparatus and an image restoration method in which a vibration is detected to restore a blurred image into an image without any blurring.

2. Description of the Related Art

In image pick-up apparatuses (e.g., a digital camera, a video camera, etc.), images deteriorated by vibrations at an image pick-up time are corrected to restore the images close to original images. For example, in the digital camera (hereinafter sometimes referred to simply as the camera), in correction of the vibration in a still image or the like, a locus of camera shake is detected using an angular velocity sensor or the like at the image pick-up time, and a predetermined image restoring operation is performed based on the detected locus of shake after the image pick-up.

It has been proposed that the vibration be corrected with a point spread function (PSF) in restoring the image without any blurring. When the point spread function is utilized, the image can be comparatively easily restored. Here, as to the restored image corrected with the point spread function, a luminance value of a pixel on a vibration locus is used as a function, but pixel influences other than the vibration locus cannot be ignored. Therefore, the vibration locus calculated from the point spread function does not completely correspond to that of the blurred image, and it is difficult to restore the image accurately. The correction of the vibration in the image is not suitable for a through image, because the predetermined image restoring operation is performed after the image pick-up.

To solve the problem, in Jpn. Pat. Appln. KOKAI Publication No. 11-134481, the blurred image is restored from the blurred image and the point spread function obtained from vibration locus data. Accordingly, during the restoration, the restored image is produced in consideration of the luminance values of the pixels around the vibration locus. According to this image restoration method, the pixel influences other than the vibration locus are also considered, and a more satisfactory restored image is obtained than before.

### BRIEF SUMMARY OF THE INVENTION

According to a first mode of the present invention, there is provided an image pick-up apparatus comprising:
an optical system which forms a subject image;
an image pick-up unit which obtains image data from the subject image formed by the optical system;
a vibration detecting unit which detects a vibration of the image pick-up apparatus;
a vibration detecting signal storage unit which stores a vibration detecting signal of a time series output from the vibration detecting unit during an exposure of the image pick-up unit;
an image deterioration information storage unit in which information of image deterioration generated by the optical system is stored;
an image deterioration correcting unit which corrects the image deterioration generated by the optical system with respect to the image data output from the image pick-up unit in accordance with the image deterioration information stored in the image deterioration information storage unit; and
a vibration restoring unit which restores the image deteriorated by the vibration with respect to the image data output from the image deterioration correcting unit in accordance with the vibration detecting signal of the time series stored in the vibration detecting signal storage unit.

According to a second mode of the present invention, there is provided an image pick-up apparatus comprising:
an optical system which forms a subject image;
an image pick-up unit which obtains image data from the subject image formed by the optical system;
a vibration detecting unit which detects a vibration of the image pick-up apparatus;
a vibration detecting signal storage unit which stores a vibration detecting signal of a time series output from the vibration detecting unit during an exposure of the image pick-up unit;
an image deterioration information storage unit in which information of image deterioration generated by the optical system is stored;
an image deterioration correcting unit which corrects the image deterioration generated by the optical system with respect to the image data output from the image pick-up unit in accordance with the image deterioration information stored in the image deterioration information storage unit;
a vibration restoring unit which restores the image deteriorated by the vibration with respect to the image data output from the image deterioration correcting unit in accordance with the vibration detecting signal of the time series stored in the vibration detecting signal storage unit;
a compression unit which compresses the image data output from the vibration restoring unit; and
a recording unit which records the image data output from the compression unit in a recording medium.

According to a third mode of the present invention, there is provided an image pick-up apparatus comprising:
an optical system which forms a subject image;
an image pick-up unit which obtains image data from the subject image formed by the optical system;
a vibration detecting unit which detects a vibration of the image pick-up apparatus;
a vibration detecting signal storage unit which stores a vibration detecting signal of a time series output from the vibration detecting unit during an exposure of the image pick-up unit;
a distortion information storage unit in which information relating to a distortion generated by the optical system is stored;
a distortion correcting unit which corrects the distortion generated by the optical system with respect to the image data output from the image pick-up unit in accordance with the information relating to the distortion stored in the distortion information storage unit;
a vibration restoring unit which restores the image deteriorated by the vibration with respect to the image data output from the distortion correcting unit in accordance with the vibration detecting signal of the time series stored in the vibration detecting signal storage unit;
a distortion inverse correction unit which inversely corrects the distortion by a predetermined amount in a barrel-type direction with respect to the image data output from the vibration restoring unit; and
a recording unit which records the image data output from the distortion inverse correction unit in a recording medium.

According to a fourth mode of the present invention, there is provided an image restoration method comprising:
obtaining image data by photographing;
detecting a vibration at a time of the photographing;
correcting the image data obtained by the photographing based on image deterioration information of an optical system; and
restoring the corrected image data, which is deteriorated by the vibration, based on the vibration.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1A is a front surface perspective view of a digital camera in first and second embodiments of the present invention;

FIG. 1B is a back surface perspective view of the digital camera in the first and second embodiments of the present invention;

FIG. 2 is a schematic diagram of a lens unit;

FIG. 3 is a diagram showing a constitution of a control circuit of the digital camera in the first and second embodiments;

FIG. 4A is a diagram showing a concept of electronic vibration correcting in a still image, and showing changes of a vibration rotary angle Ox in an X-axis direction;

FIG. 4B is a diagram showing the concept of the electronic vibration correcting in the still image, and showing changes of a vibration rotary angle θy in a Y-axis direction;

FIG. 4C is a diagram showing the concept of the electronic vibration correcting in the still image, and showing a vibration locus on an image pick-up device;

FIG. 4D is a diagram showing the concept of the electronic vibration correcting in the still image, and showing a relation between an original image and a picked-up image;

FIG. 5A is a diagram showing the concept of the electronic vibration correcting in a moving image, and showing three varying frames;

FIG. 5B is a diagram showing the concept of the electronic vibration correcting in the moving image, and showing an image indicating that three frames are simply successively displayed;

FIG. 5C is a diagram showing the concept of the electronic vibration correcting in the moving image, and showing an image indicating that corrected images are successively displayed;

FIG. 6A is a diagram showing electronic vibration correcting amounts in moving images and through images in a moving image mode, and through images in a still image mode and a still image;

FIG. 6B is a diagram showing a CCD image indicating image cutout ranges in the moving images and the through images in the moving image mode, and the through images in the still image mode and the still image;

FIG. 7 is a first half of a flowchart showing a main process of an image restoring operation in the first and second embodiments;

FIG. 8 is a last half of the flowchart showing the main process of the image restoring operation in the first and second embodiments;

FIG. 9 is a diagram showing a constitution of a control circuit of a digital camera in a third embodiment of the present invention;

FIG. 10 is a flowchart showing a process of a sequence control circuit in the third embodiment;

FIG. 11A is a schematic diagram of an image distortion in the third embodiment in a case where the distortion is zero;

FIG. 11B is a schematic diagram of the image distortion in the third embodiment, showing a barrel type distortion;

FIG. 11C is a schematic diagram of the image distortion in the third embodiment, showing a pin-cushion type distortion;

FIG. 11D is a schematic diagram of the image distortion in the third embodiment, showing a relation between image height and correction of the distortion;

FIG. 11E is a schematic diagram of the image distortion in the third embodiment, showing the image height;

FIG. 12 is a flowchart showing a process of the sequence control circuit in restoration of the image distortion;

FIG. 13 is a diagram showing a constitution of a control circuit of a digital camera in a fourth embodiment of the present invention;

FIG. 14 is a diagram showing a constitution of a control circuit of a digital camera of a first modification in the fourth embodiment of the present invention; and

FIG. 15 is a diagram showing a constitution of a control circuit of a digital camera of a second modification in the fourth embodiment of the present invention.

### DETAILED DESCRIPTION OF THE INVENTION

Embodiments of the present invention will be described hereinafter with reference to the drawings.

### First Embodiment

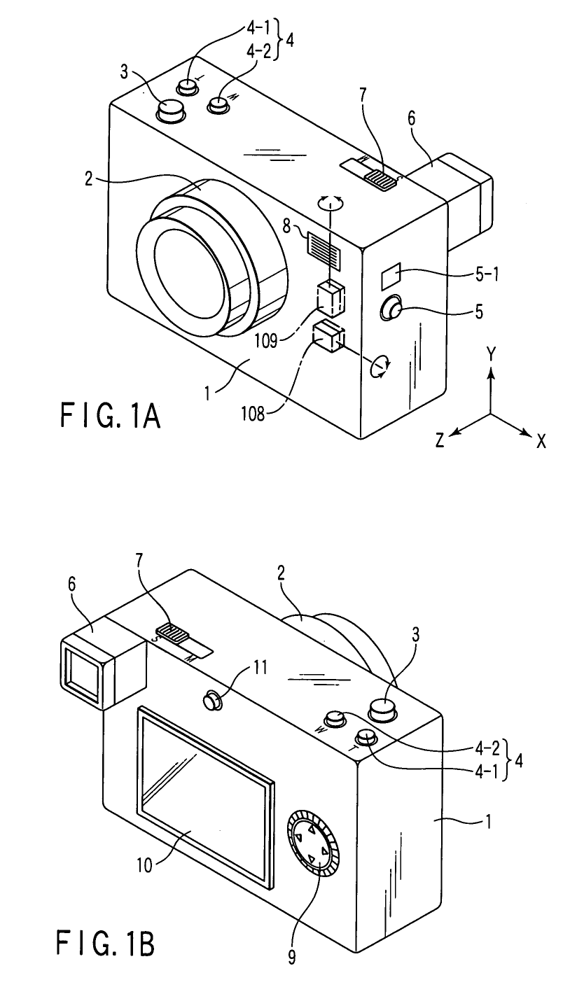

FIG. 1A is a front surface perspective view of a digital camera which is one example of an image pick-up apparatus according to a first embodiment of the present invention, and FIG. 1B is a back surface perspective view of the digital camera which is one example of the image pick-up apparatus according to the first embodiment of the present invention.

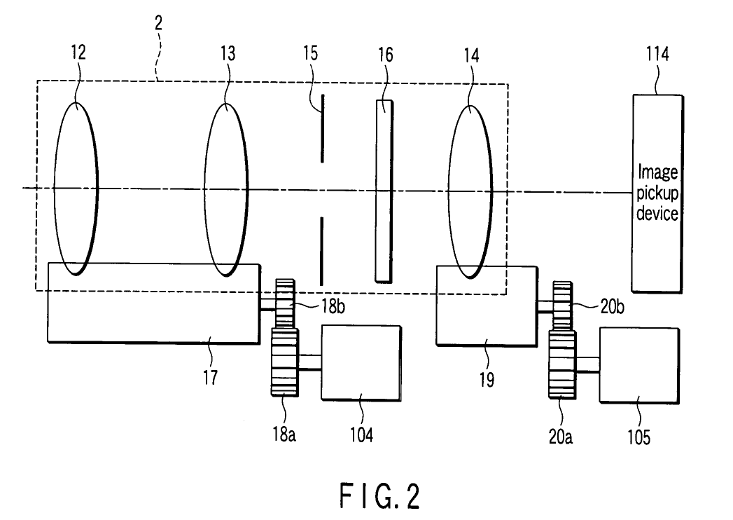

As seen from FIG. 1A, a lens unit 2 is connected to a front surface of a camera body 1. As seen from FIG. 1B, a finder (view finder) 6 is integrally assembled to a back surface of the camera body 1. The lens unit 2 comprises a plurality of lens for photography, and a driving section. The lens unit 2 will be described later in detail with reference to FIG. 2.

When a release switch 3 is pressed (turned on), a photographing operation is started. A zoom switch 4 includes a T button 4-1 and a W button 4-2. When the T button is pressed, a magnification of the photographing lens is changed to a telescope side. When the W button is pressed, the magnification of the lens is changed to a wide side. When a vibration mode switch 5 is pressed, a mode of the camera is set to a vibration mode. In this case, a mode lamp 5-1 is lit. Accordingly, a photographer sees that the camera is brought into the vibration mode.

The view finder 6 is an electronic view finder, for example, in which a small-sized LCD is enlarged by a loupe. By the view finder 6, a so-called through image can be displayed which displays an image of an image pick-up device (CCD) in real time. A mode key (sliding key) 7 is a changeover key to a still image or a moving image. When the mode key 7 is set to an S-side (STILL), a still image mode is set. When the mode key is set to an M-side (MOVIE), a moving image mode is set.

A flash 8 emits light at a time when luminance is low to illuminate a subject. A mode operation key 9 is constituted by four buttons arranged around a determination button. By this mode operation key 9, macro photography, self timer, flash or the like is turned on. In a back-surface LCD panel 10, a photographed image is reproduced, and the through image can be displayed. The back-surface LCD panel 10 is utilized as a monitor together with the view finder 6. When a power switch 11 is pressed, exposure, image pick-up or the like is possible in the camera.

FIG. 2 is a schematic diagram of the lens unit 2 which is an optical system. The lens unit 2 has, for example, three lenses 12, 13, 14. Among the three lenses, the lenses 12, 13 are magnification varying lenses (zoom lenses) whose mutual positional relation is changed to thereby change a focal distance of each lens. During zooming, a driving force of a zoom motor 104 is transmitted to a lens driving cam mechanism 17 for zoom via gears 18a, 18b. Moreover, the lenses 12, 13 are moved along an optical axis by the lens driving cam mechanism 17 for zoom.

The lens 14 is a focus lens which moves forwards/backwards along the optical axis to adjust focusing. During focus adjustment, a driving force of a focus motor 105 is transmitted to a lens driving cam mechanism 19 for focus via gears 20a, 20b. Moreover, the lens 14 is moved by the lens driving cam mechanism 19 for focus. For example, an image pick-up device (image pick-up unit) 114 constituted of a CCD is positioned behind the lens 14. A light beam passed through the lenses 12, 13, 14 is formed into an image on the image pick-up device 114, and photoelectrically converted by each pixel of the image pick-up device. Accordingly, the image is picked up. A quantity of light (exposure amount) onto the image pick-up device 114 is controlled by a aperture 15 and a shutter 16. Instead of the mechanical shutter 16, a device shutter (electronic shutter) of the image pick-up device 114 may be used.

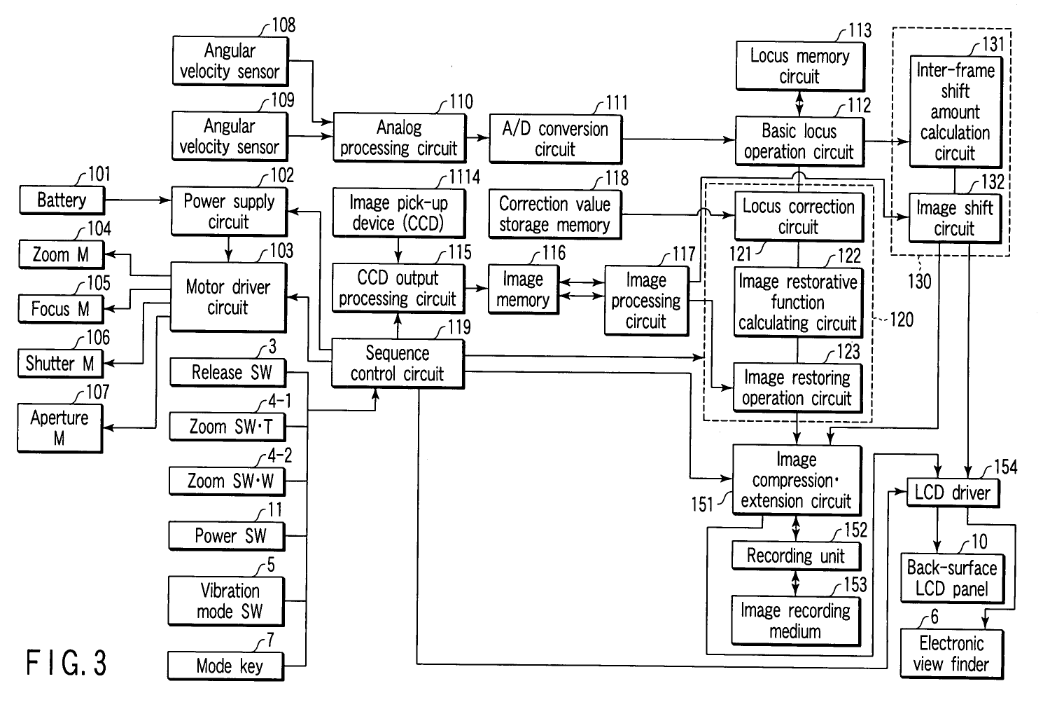

FIG. 3 is a block diagram of a control circuit of the digital camera. A battery 101 comprises a chargeable battery such as a lithium ion charging battery. A power supply circuit 102 produces a power source having a voltage required in each processing circuit from a voltage of the battery 101 by a step-up or step-down circuit to supply power to each processing circuit. A motor driver circuit 103 comprises an electric circuit including a switching transistor. The motor driver circuit 103 drives and controls the zoom motor 104, the focus motor 105, a shutter motor 106, and a aperture motor 107 in accordance with instructions of a sequence control circuit 119. Angular velocity sensors 108, 109 detect angular velocities around X-axis and Y-axis which cross each other at right angles. As shown in FIG. 1A, the angular velocity sensors 108, 109 are disposed along axes which are longitudinal directions of elements, and arranged in a direction in which the axes cross each other at right angles to detect angular velocities along the axes.

An analog processing circuit 110 cancels offsets of outputs of the angular velocity sensors 108, 109 and amplifies outputs of the angular velocity sensors 108, 109. Here, the analog processing circuit 110 constitutes a vibration detecting unit together with the angular velocity sensors 108, 109. An output of the analog processing circuit 110 is converted into a digital signal by an A/D conversion circuit 111, and input into a basic locus operation circuit 112. The basic locus operation circuit 112 integrates inputs from the A/D conversion circuit 111 with time to thereby calculate a displacement angle for each time. Moreover, the circuit outputs this displacement angle in accordance with the time, that is, outputs the angle in a time series, and calculates vibration locus in a vertical or horizontal direction by the vibration of the image in the vicinity of the optical axis on an image pick-up surface of the image pick-up device 114. Here, vibration detectors are not limited to the angular velocity sensors 108, 109. Instead of the angular velocity sensors 108, 109, angular acceleration sensors, or a pair of acceleration sensors may be used as long as an operation process is changed. A locus memory circuit 113 is a memory which stores a vibration locus detected by the basic locus operation circuit 112 and which functions as a vibration detecting signal storage unit.

An image pick-up device 114 comprises a CCD positioned behind the lens unit 2 described with reference to FIG. 2. It is to be noted that the image pick-up device 114 is driven and controlled via a CCD driver (not shown) in accordance with a control signal from the sequence control circuit 119. A CCD output processing circuit 115 processes an output from the image pick-up device (CCD) 114. An image memory 116 temporarily holds output data from the image pick-up device 114 and image data being processed in the CCD output processing circuit 115. An image processing circuit 117 subjects the data stored in the image memory 116 to basic processes such as an RGB process and a shading correction process. It is to be noted that the image processing circuit 117 does not perform γ conversion or image compression which makes an obstruction to a restoring operation of a blurred image. These processes are performed by an image compression•extension circuit 151 described later. The data processed by the image processing circuit 117 is sent to an image restoring operation circuit 123 and an image shift circuit 132.

An image restorative function calculating circuit 122 calculates an image restorative function f⁻¹ for restoring the deterioration of the image by the vibration. Here, the image restorative function f⁻¹ is a reverse function of an image deteriorative function f generated by the vibration. The image restorative function f⁻¹ is calculated by predicting a change from an original image from an output of the basic locus operation circuit 112. It is to be noted that the image restorative function f⁻¹ is directly calculated from the output from the basic locus operation circuit 112 in a middle of a screen. However, with regard to areas other than the screen middle, the lenses 12, 13, 14 of the digital camera generate the distortions of the images which are dependent on zoom and focus positions, and therefore the output from the basic locus operation circuit 112 needs to be corrected. Therefore, in the digital camera of the first embodiment, locus correction data for correcting the distortions of the images corresponding to the zoom and focus positions are stored for each area of the screen in a correction value storage memory 118 (distortion information storage unit).

For example, when a peripheral image of the screen is compressed with respect to an image of the screen middle by the influence of the distortion, a locus change is accordingly compressed. Therefore, a locus correction circuit 121 first corrects locus data output from the basic locus operation circuit 112 based on a value of the correction value storage memory 118 for each screen area. Moreover, the corrected locus data is output to the image restorative function calculating circuit 122. That is, the locus correction data stored in the correction value storage memory 118 is input into the locus correction circuit 121, and the image restorative function calculating circuit 122 calculates the image restorative function f⁻¹ for each screen area based on the output from the locus correction circuit 121.

The data which is not subjected to the γ conversion or the image compression is sent from the image processing circuit 117 to the image restoring operation circuit 123. The image restoring operation circuit 123 converts the image using the image restorative function f⁻¹ calculated for each area of the screen in the image restorative function calculating circuit 122. With regard to an image from which the influence of the image distortion has been eliminated to restore the image deterioration by the vibration in the image restoring operation circuit 123, data of the image is compressed by the image compression•extension circuit 151, and thereafter written into an image recording medium 153 such as a built-in flash memory via a recording unit 152. Instead of the built-in flash memory, an external memory such as a charging type memory card may be used as the image recording medium 153. It is to be noted that the locus correction circuit 121, the image restorative function calculating circuit 122, and the image restoring operation circuit 123 form an electronic vibration correcting circuit 120 for the still image, which electronically corrects the image distortions of the lenses 12, 13, 14 for each area of the screen. Moreover, the locus correction circuit 121 functions as a vibration detecting signal correction unit, the image restorative function calculating circuit 122 functions as an image restorative function calculating unit, the image restoring operation circuit 123 functions as a vibration restoring unit, and the image compression•extension circuit 151 functions as a compression unit.

The sequence control circuit 119 comprises a CPU such as a microcomputer. The sequence control circuit 119 detects on•off states of the release switch 3, the zoom switches 4 (T, W), the power switch 11, the vibration mode switch 5, the mode key 7 and the like, and controls movement of each constituent element based on detection results to control the whole digital camera. Specifically, the sequence control circuit 119 functions as a sequence controller, a continuous operation unit which continuously operates the image pick-up device, a display control unit which controls the display of the monitor (view finder 6, back-surface LCD panel 10), and controllers of first and second vibration correcting units (image restoring operation circuit 123, image shift circuit 132).

An inter-frame shift amount calculation circuit 131 calculates a shift amount between frames in a period in which the through image is acquired. The inter-frame shift amount calculation circuit 131 receives a locus of vibration for each frame period from the basic locus operation circuit 112, and calculates an amount by which the corresponding image is to be shifted. The image shift circuit 132 receives an output from the image pick-up device (CCD) 114 via the image memory 116. Moreover, the image is shifted by a vibration amount based on an output from the inter-frame shift amount calculation circuit 131 to correct the vibration in the moving image (or the through image). The inter-frame shift amount calculation circuit 131 and the image shift circuit 132 form an electronic vibration correcting circuit 130 for the moving image. Moreover, assuming that the image restoring operation circuit 123 for the still image is a first vibration correcting unit, the image shift circuit 132 for the moving image may be a second vibration correcting unit.

With regard to the moving image in which the vibration has been corrected in the moving image electronic vibration correcting circuit 130, data is compressed by the image compression•extension circuit (compression unit) 151, and recorded in the image recording medium 153 via the recording unit 152. The image, regardless of the still image or the moving image, in which the vibration has been corrected, is sent and displayed as a monitor image in the back-surface LCD panel 10 or the view finder 6 disposed on the back surface of the camera body. Therefore, the image compression•extension circuit 151 also has an extending function for displaying the image data, read from the image recording medium 153 via the recording unit 152, in the back-surface LCD panel 10 or the view finder 6. It is to be noted that when the output from the image restoring operation circuit 123 is recorded in the image recording medium 153 like the built-in flash memory or the external memory (e.g., the charging type memory card) via the recording unit 152, a sharp image in the whole screen can be recorded.

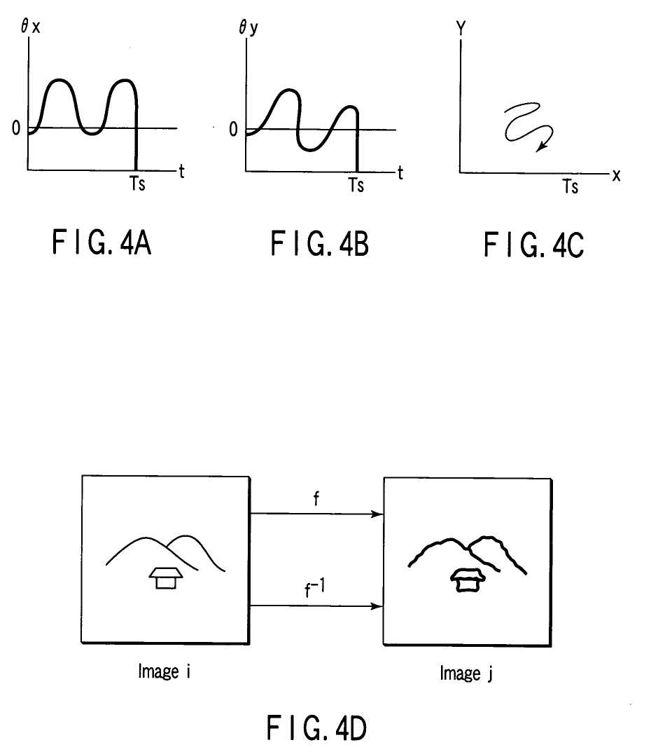

Next, electronic vibration correcting in the still image will be described. FIGS. 4A to 4D are diagrams showing concepts of the electronic vibration correcting in the still image. More specifically, FIG. 4A is a diagram showing changes of a vibration rotary angle θx in an X-axis direction, FIG. 4B is a diagram showing changes of a vibration rotary angle θy in a Y-axis direction, FIG. 4C is a diagram showing a vibration locus on the image pick-up device (CCD) 114, and FIG. 4D is a diagram showing a relation between an original image and a picked-up image.

As described with reference to FIG. 3, with regard to the vibrations of the X-axis and the Y-axis, detected by the angular velocity sensors 108, 109, data of the displacement angles θx, θy are output to the basic locus operation circuit 112 in accordance with time, that is, in a time series as shown in FIGS. 4A and 4B. Next, since a focal distance of the lens is seen from the zoom position at a time when the data of the displacement angles θx, θy are output, as shown in FIG. 4C, a displacement locus of the vibration on the image pick-up device (CCD) 114 is calculated by paraxial calculation. Moreover, the image deteriorative function f by the vibration is calculated from the vibration locus on the image pick-up device 114. Here, it is seen from the image deteriorative function f that a picked-up image (original image) i is deteriorated into a blurred image j. Therefore, the reverse function f⁻¹ of f, that is, the image restorative function can be obtained. The picked-up image i is restored by inversion using the image restorative function f⁻¹.

As described above, as to the still image, the image deteriorative function f is calculated from the vibration locus on the image pick-up device 114 based on the time-series vibration by the vibration at the photographing time, and the blurred image is restored by the inversion by the reverse function f⁻¹ of f, that is, the image restorative function. In this case, the vibration locus is corrected in the locus correction circuit 121, and the influence of the distortion of the optical system is removed. Therefore, even when there is a distortion in the optical system, the accurate image locus by the vibration is output for each screen area from the middle to the periphery of the screen. Consequently, the accurate restoration of the image deteriorated by the vibration can be performed over the whole screen, and the sharp image can be obtained in the whole screen

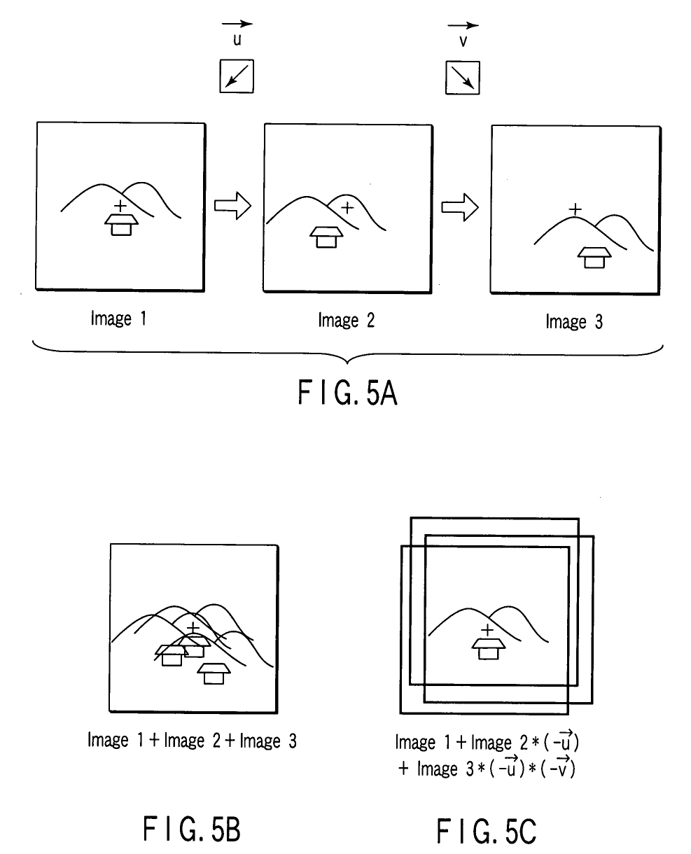

FIGS. 5A to 5C are diagrams showing the concepts of the electronic vibration correcting in the moving image. More specifically, FIG. 5A is a diagram showing three varying frames, FIG. 5B is a diagram showing an image indicating that three frames are simply successively displayed, and FIG. 5C is a diagram showing an image indicating that corrected images are successively displayed. That is, the image of FIG. 5B corresponds to an image in which the vibration is not corrected, and the image of FIG. 5C corresponds to an image in which the vibration has been corrected.

As to the moving image, since a shift between the frames is recognized as the vibration, the vibration is corrected by image shift. For example, when three images 1, 2, 3 shown in FIG. 5A are considered, vector movement is assumed in a direction shifting toward a lower left side as shown by (u→) on a figure surface between the images 1 and 2, and vector movement is assumed in a direction shifting toward a lower right side as shown by (v→) on the figure surface between the images 2 and 3. In this case, when the images 1, 2, 3 are simply successively displayed, as shown in FIG. 5B, the image seems to be blurred. On the other hand, when the images are shifted by reverse vectors of u→ and v→, and successively displayed, (image 1+image 2*(−u→)+image 3*(−u→)*(−v→)), and a clear image is seen without any vibration as shown in FIG. 5C. Here, “*” denotes an operator indicating the image shift.

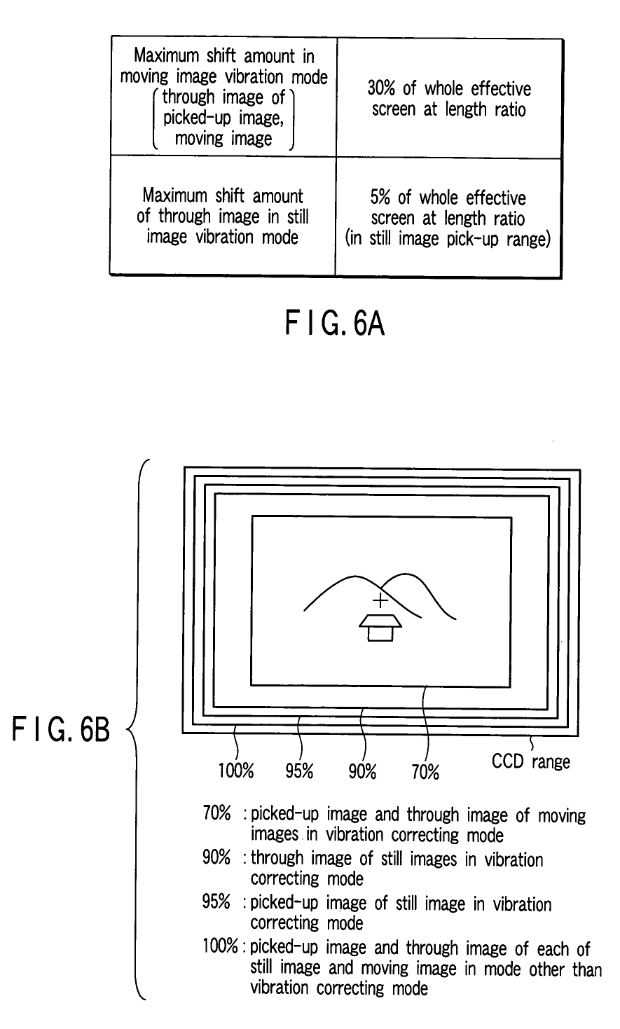

FIG. 6A is a diagram showing electronic vibration correcting amounts (maximum shift amounts) in moving images and through images in a moving image mode, and through images in a still image mode and still images, and FIG. 6B is a diagram showing image cutout ranges in the moving images and the through images in the moving image mode, and through images in the still image mode and the still images.

It is assumed that an image pick-up range of a CCD image is 100% in a case where a mode is not a vibration mode. In this case, in the vibration mode of the still image, the image has a predetermined spread in accordance with the image restorative function. If there is not any image data outside the image pick-up range, the peripheral image cannot be corrected. Therefore, a range of 95% is assumed as the image pick-up range in terms of a diagonal length ratio. Moreover, the picked-up image in this image pick-up range is subjected to the electronic vibration correcting, and recorded. Here, the vibration amount of the still image is small within an exposure time as compared with a case where the moving image is successively shifted, and a peripheral margin may be small as compared with the moving image.

A size of an effective image pick-up range in a moving image vibration mode is small as compared with the still image, and is assumed, for example, as a range of 70% in terms of the diagonal length ratio. This is because the moving image is shifted, and more time is therefore required, and a shift amount is large as compared with the still image.

Next, an image pick-up range of the image displayed by the through image will be described. In a case where both of the still image and the moving image are not brought into the vibration correcting mode, a range to be picked up and recorded corresponds to 100% in terms of a diagonal ratio in the CCD. In this case, the image in a range of 100% in terms of the diagonal ratio in the CCD is displayed also with respect to the through image.

On the other hand, a range equal to the range to be picked up and recorded is displayed as the through image in the vibration correcting mode in the photographing of the moving image. This range corresponds to a size of 70% in terms of the diagonal ratio, and the image is successively shifted (moved) in a range (range of 100% in terms of the diagonal ratio) of an effective pixel of the CCD in order to correct the vibration. On the other hand, the picked up and recorded range in the CCD is different from the range indicated by the through image in the CCD in the vibration correcting mode in the photographing of the still image. This is because a vibration correcting system at a time when the image is picked up and recorded is different from that at a time when the through image is displayed. However, the picked up and recorded range needs to substantially agree with the range indicated by the through image even in the different vibration correcting systems. Therefore, for example, the picked up and recorded range is 95% in terms of the diagonal ratio in the CCD, whereas the range of the through image is a size of 90% in terms of the diagonal angle in the CCD in the vibration correcting mode in the photographing of the still image. The range of the through image is successively shifted in a range of 95% in terms of the diagonal ratio in the CCD to correct the vibration. In this case, a vibration correcting amount (shift amount) of the through image of the still image is a range of 5%. Since a maximum shift amount is small as compared with the through image of the moving image, large vibration cannot be handled, but the range substantially equal to the picked-up•recorded range of the still image can be displayed in the view finder 6 or the back-surface LCD panel 10.

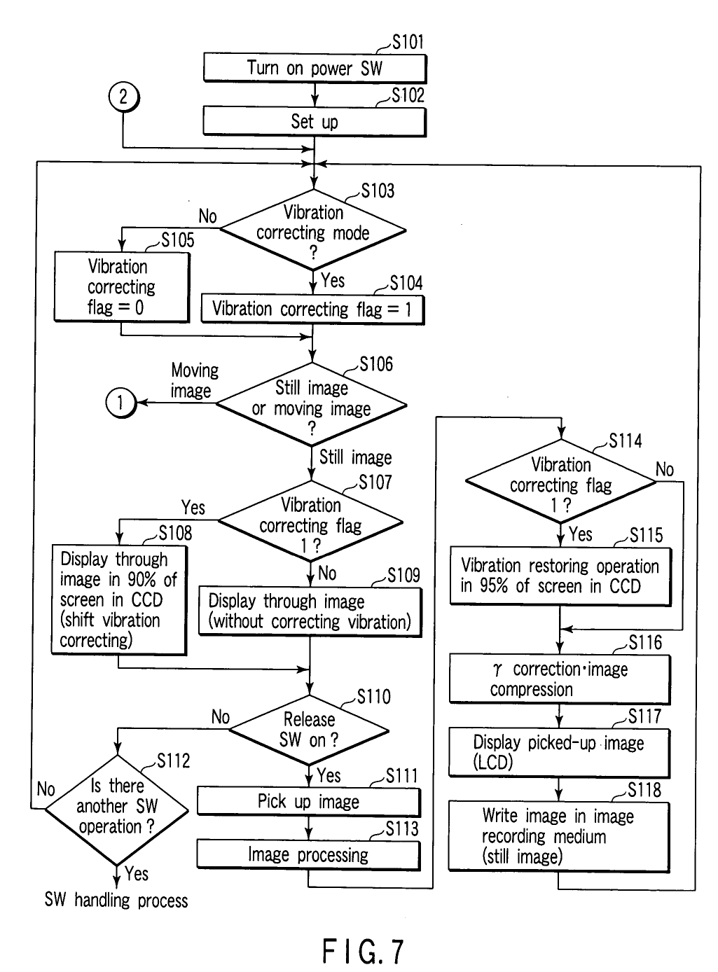

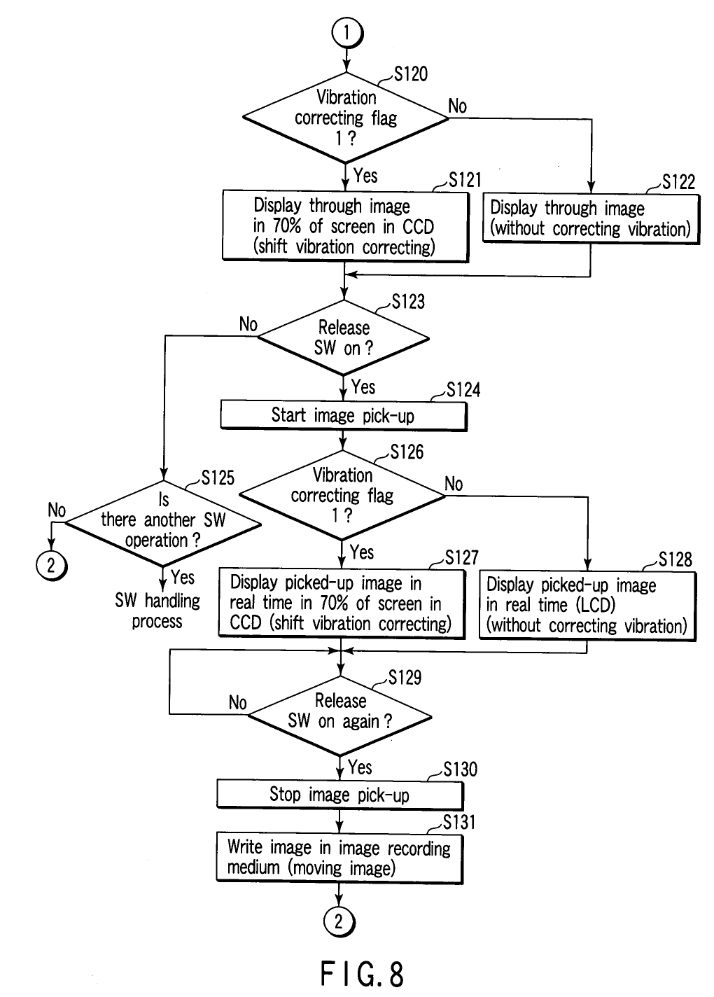

FIGS. 7 and 8 show a main flowchart of an image restoring operation. First, when a photographer presses the power switch 11 (S101), a lens having a depressed state is set up (S102). Moreover, it is judged by the state of the vibration mode switch 5 whether or not the vibration correcting mode is set (S103). Here, every time the vibration mode switch 5 is pressed, the switch is repeatedly turned on and off. When the switch is turned on, the mode lamp 5-1 is lit, and a vibration correcting flag is set to 1 (S104). When the switch is turned off, the mode lamp 5-1 is turned off, and the vibration correcting flag is set to 0 (S105).

Next, it is judged whether a mode is a still or moving image mode (S106), and the process shifts to S120 of FIG. 8 in the moving image mode in which the mode key 7 is positioned on the M-side. On the other hand, in the still image mode in which the mode key 7 is positioned on the S-side, it is judged whether or not the vibration correcting flag is 1 (S107). When the vibration correcting flag is 1, the through image in which the vibration has been corrected is displayed utilizing a screen range of 90% (S108). When the vibration correcting flag is 0, the through image is displayed, but the vibration is not corrected, and the through image which remains to be blurred is displayed (S109). Here, either of the view finder 6 and the back-surface LCD panel 10 is selected as the LCD to be displayed by the photographer (user), and the through image is displayed in the selected LCD. The image may be displayed in both of the view finder 6 and the back-surface LCD panel 10, and the photographer may see either display.

Subsequently, it is confirmed that the release switch 3 is on (S110). When the switch is on (the release switch 3 is pressed), the still image is picked up (S111). On the other hand, when the release switch 3 is not pressed, it is judged whether or not another switch is operated (S112). When any of the switches is turned on, a process corresponding to the switch is performed. When any of the switches is turned off, the process is returned to S103.

After picking up the still image, the resultant image is processed by the image processing circuit 117 (S113). Thereafter, it is judged whether or not the vibration correcting flag is 1 (S114). When the vibration correcting flag is 1 in S114, the image restorative function from which the influence of the image distortion has been eliminated is calculated for each area of the screen in the image restorative function calculating circuit 122. Moreover, the vibration is corrected utilizing a screen range of 95% in the image restoring operation circuit 123 (S115). On the other hand, when the vibration correcting flag is 0 in S114, any vibration is not corrected. In S116, after performing image processing such as γ conversion and image compression in the image compression•extension circuit 151, the resultant picked-up image (still image) is displayed in the back-surface LCD panel 10 or the like (S117). The picked-up image is written into the image recording medium 153 via the recording unit 152 (S118). After ending the writing, the process is returned to S103.

Next, a main flowchart for the moving image will be described with reference to FIG. 8. When the moving image mode is set in S106 of FIG. 7 (the mode key 7 is positioned on the M-side), it is judged whether or not the vibration correcting flag is 1 (S120). When the vibration correcting flag is 1, in the image shift circuit 132, the picked-up image is shifted by the shift amount calculated by the inter-frame shift amount calculation circuit 131, and the through image, in which the vibration has been corrected, is displayed utilizing a screen range of 70% (S121). On the other hand, when the vibration correcting flag is 0, the through image is displayed, but any vibration is not corrected, and the blurred image is displayed in the LCD (S122). It is to be noted that the image of FIG. 5B corresponds to the blurred through image of S122, and the image of FIG. 5C corresponds to the shifted and corrected through image of S121.

Moreover, it is confirmed that the release switch 3 is on (S123). When the switch is on (the release switch is pressed), the photographing of the moving image is started (S124), and it is judged whether or not the vibration flag is 1 (S126). When the release switch 3 is not pressed, it is judged whether or not another switch is operated (S125). When any of the switches is on, a process corresponding to the turned-on switch is performed. When any of the switches is off, the process is returned to S103.

When the vibration correcting flag is 1 in S126, the image is shifted utilizing a screen range of 70%, and the picked-up image, in which the vibration has been corrected, is displayed in the LCD in real time (S127). On the other hand, when the vibration correcting flag is 0, any vibration is not corrected, and the picked-up image, which remains to be blurred, is displayed in the LCD in real time (S128). In the same manner as in the displaying of the through image in S121, S122, the blurred picked-up image of S128 is displayed like the image of FIG. 5B, and the picked-up image shifted and corrected in S127 is displayed like the image of FIG. 5C. Moreover, the image is continuously picked up until the release switch 3 is pressed again. When the release switch is again pressed (S129), the image pick-up is stopped (S130), the moving image is written into the image recording medium 153 (S131), and the process is returned to S103.

By this constitution, even at the time of the photographing of the still image or the moving image, it can be confirmed by the view finder 6 and the back-surface LCD panel 10 that the vibration is being corrected, and the range of the through image substantially agrees with a range in which the image can be actually picked up. Accordingly, framing can be easily and quickly set. Since the locus by the image distortion is corrected for each screen range, the influence of the image distortion by the lens is eliminated, an accurate change amount of the locus is obtained for each screen range, and satisfactory vibration correcting can be performed over the whole screen.

Next, a first modification of the first embodiment will be described. In the first embodiment, the locus data output from the basic locus operation circuit 112 is corrected for each image area based on the value of the correction value storage memory 118 in the locus correction circuit 121, and the corrected locus data is output to the image restorative function calculating circuit 122. Next, the image restorative function f⁻¹ is calculated for each screen area based on the output from the locus correction circuit 121 in the image restorative function calculating circuit 122, and the operation for restoring the image is performed based on the image restorative function f⁻¹ in the image restoring operation circuit 123. On the other hand, the following may be performed in the modification.

First, the locus correction circuit 121 is omitted, and the output line from the correction value storage memory 118 is modified in such a manner as to be connected to the image restorative function calculating circuit 122. Moreover, the locus data output from the basic locus operation circuit 112 is directly processed in the image restorative function calculating circuit 122, and only one type of image restorative function f⁻¹ is calculated and obtained. Next, the image restorative function f⁻¹ is corrected for each image area based on the value of the correction value storage memory 118 to obtain the image restorative function f⁻¹ which differs with each image area. Next, in the image restoring operation circuit 123, the image is restored in accordance with the image restorative function f⁻¹ which differs with the image area. In this modification, the image restorative function calculating circuit 122 functions as an image restorative function calculating unit, and also as an image restorative function correcting unit.

According to the constitution of the modification, even when the same vibration is generated, the locus of the movement of the image changes with each of the screen middle and the area other than the screen middle by the influence of the distortion, because the image is compressed or enlarged, or a direction of the image is changed. As a result, even when the image deteriorative function f differs with each area, the image deteriorative function f may be corrected with each area to obtain an optimum image restorative function f⁻¹. Consequently, the accurate restoration of the image deteriorated by the vibration can be performed over the whole screen, and the sharp image is obtained in the whole screen.

### Second Embodiment

Even in a camera provided with a vibration correcting unit in which a restoring operation is performed from image data obtained after a still image is photographed, the vibration correcting unit for performing the above-described type of image restoring operation cannot be applied to through image display for observing a subject in a preparatory stage for the photographing of the still image. Even when the unit is applied, target effects cannot be obtained. To solve the problem, in a second embodiment, vibration correcting is performed which differs with the time of the photographing of the still image and the time of the displaying of the through image as shown in FIGS. 7, 8. That is, the vibration correcting for the moving image (through image) is performed at the time of the displaying of the through image, and the different type of vibration correcting is performed for the still image at the time of the photographing of the still image. Furthermore, the through image in a still image mode is different from that in a moving image mode in an image cutout range, a maximum correction amount or the like in an electronic vibration preventing operation. That is, a vibration correcting mode is set in such a manner that the image cutout range, the maximum correction amount and the like are optimized for each of the still image and the moving image. Accordingly, the vibration correcting for the moving image is performed at a vibration correcting time. When the still image is picked up, vibration restoring correction is performed based on a vibration locus, and thereafter a restored image is displayed.

In the second embodiment, when a vibration preventing mode is set, a through image having less vibration is displayed by the another type of vibration correcting which is effective for the through image with respect to the through image. Accordingly, a photographer can be notified that a vibration mode is operated. Therefore, at the photographing time, the photographer can confirm that the vibration mode is set while observing the subject. Since the vibration at an observing time is reduced, the subject is easily observed. Furthermore, when the vibration correcting mode for the still image is not set, the vibration correcting for the through image is stopped. When the vibration is large, the photographer is effectively warned to notice the vibration in observing the subject, and set the vibration correcting mode.

It is to be noted that FIGS. 1 to 8 are referred to in common in the first and second embodiments. Therefore, in the second embodiment, the descriptions of FIGS. 1 to 8 are omitted.

### Third Embodiment

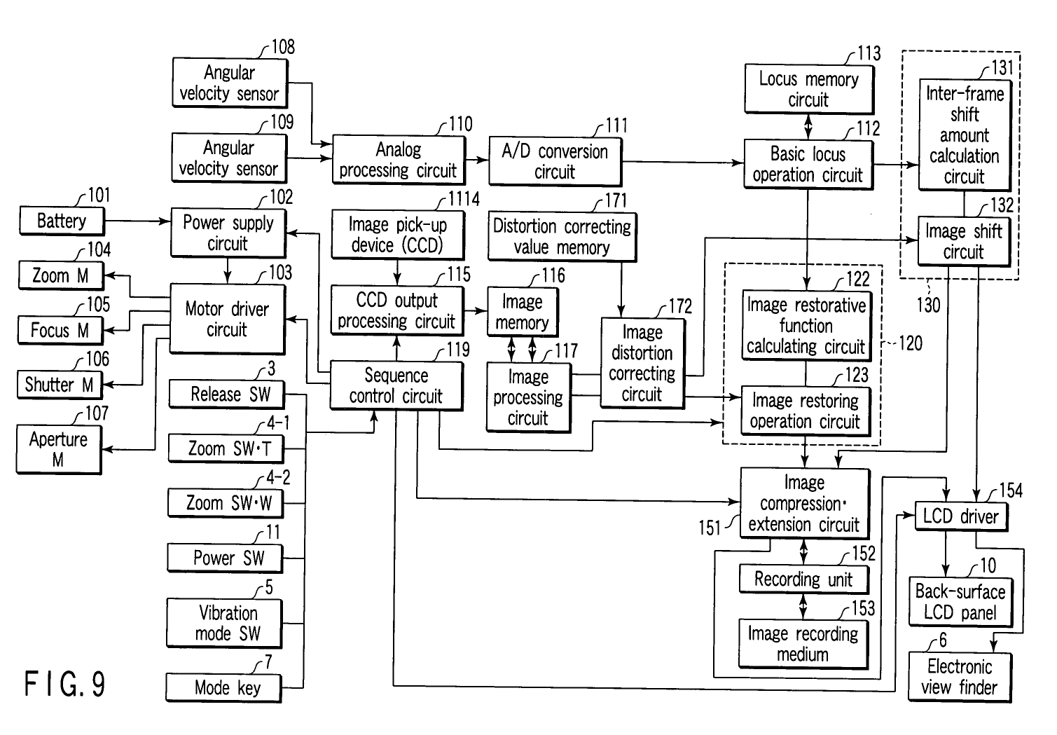

A third embodiment will be described with reference to FIGS. 9 to 12. In the embodiment, with regard to a picked-up image, after lens distortion correcting is performed, electronic vibration correcting for a still image, and that for a moving image are performed. Here, FIG. 9 is a block diagram of a control circuit of a digital camera. As shown in FIG. 9, the third embodiment is different from the embodiment of FIG. 3 in that a correction value storage memory 118 and a locus correction circuit 121 are omitted, and a distortion correcting value memory 171 (distortion information storage unit, image deterioration information storage unit) and an image distortion correcting circuit 172 are added as constituent elements. It is to be noted that even in the third embodiment, FIGS. 1 to 8 except FIG. 3 are referred to in common to the first and second embodiments. Additionally, the third embodiment is different from the first embodiment in that the picked-up image is additionally corrected in accordance with lens distortion by the image distortion correcting circuit 172 in image processing of S113 shown in FIG. 7.

In the block diagram of the control circuit of the digital camera in FIG. 9, a distortion correcting value corresponding to the lens distortion is stored in the distortion correcting value memory 171. In the image distortion correcting circuit 172, the distortion by the lens is corrected in the picked-up image based on the distortion correcting value stored in the distortion correcting value memory 171. Thereafter, the still image electronic vibration correcting and the moving image electronic vibration correcting are performed. The distortion correcting value memory 171 is used simply as a lens property correction value memory, correction data other than the distortion correcting value, such as correction data of aberration attributed to properties of a photographing lens, is also stored in the correction value memory. Furthermore, the image distortion correcting circuit 172 may be operated as a lens property correction circuit, and the aberration attributed to the properties of the photographing lens or the like may be corrected. According to the constitution, it is possible to correct image deterioration because of distortion, aberration or the like of an optical system before performing a vibration restoring operation not only in a case where there is an influence of the distortion of the photographing lens but also in a case where there is image deterioration caused by the aberration or the like of the optical system. Accordingly, after eliminating the influence of the image deterioration, the vibration restoring operation can be performed. Therefore, the accurate restoration of the image deteriorated by the vibration can be performed by a simple operation in a whole screen, and a sharp image can be obtained in the whole screen.

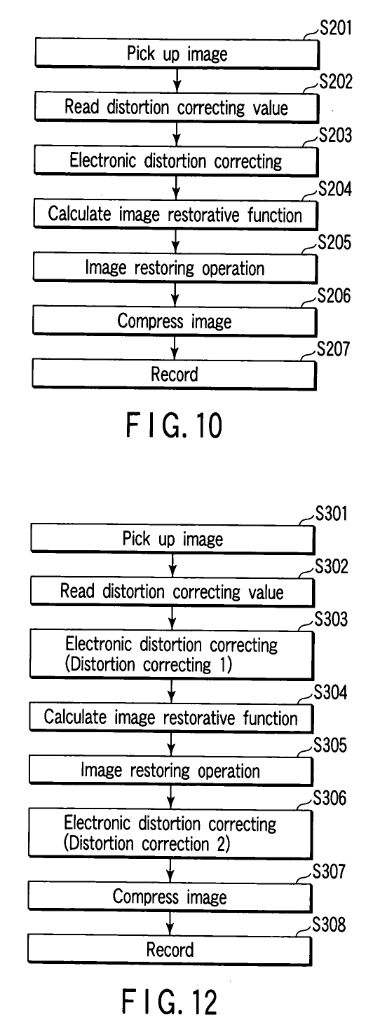

FIG. 10 shows a flowchart of a process of a sequence control circuit 119 in the third embodiment. First, when a release switch 3 is pressed, image pick-up is started (S201). Moreover, a distortion correcting value corresponding to a distortion is read from the distortion correcting value memory 171 based on zoom position and subject distance (S202), and an image distortion by the lens is corrected by the image distortion correcting circuit 172 (S203). Next, in an image restorative function calculating circuit 122, an image restorative function is calculated from a vibration locus of a time series for each area, obtained from the vibrations detected by angular velocity sensors 108, 109 (S204). The vibrations are corrected in accordance with the image restorative function in an image restoring operation circuit 123 (S205). Next, the image is compressed in an image compression•extension circuit 151 (S206), and the compressed image is recorded in an image recording medium 153 via a recording unit 152 (S207).

FIGS. 11A to 11E are schematic diagrams of image distortions in a case where a building is photographed. More specifically, FIG. 11A is a diagram showing an image in a case where the distortion is zero, FIG. 11B is a diagram showing the image under a barrel type distortion, FIG. 11C is a diagram showing the image under a pin-cushion type distortion, FIG. 11D is a diagram showing a relation between image height and distortion correction, and FIG. 11E is an explanatory view of the image height. As shown in FIG. 1E, the image height is zero in a middle of a screen, and turns to one in a periphery (outermost periphery) of the screen, and an equal image height is indicated in a concentric rectangle.

Even when the lens is formed of the same material on the same conditions, fluctuations are inevitably generated in lens properties. To restore the image correctly, differences of the lens properties need to be considered. Even when the image having the barrel type distortion as shown in FIG. 11B or the image having the pin-cushion type distortion as shown in FIG. 11C is brought close to the image whose distortion is zero as shown in FIG. 11A by electric correction, the distortion sometimes shifts from zero because of the fluctuations of the lens properties. For one thing, since an image by a fish-eye lens is familiar to human eyes, an observer does not have much sense of incongruity with respect to an image distorted like a barrel. On the other hand, the observer has a sense of incongruity with respect to an image distorted like a pin-cushion, and the image is conspicuously unnatural. Although the distortion is corrected into zero, the distortion shifts from zero by the influences of the fluctuations of the lens properties. In this case, it is preferable that a restored image turns to the image distorted like the barrel rather than the image distorted like the pin-cushion.

Therefore, as shown in FIG. 1D, an image distortion L₁ by the lens (barrel type distortion) is corrected into a targeted level L₀ indicating zero distortion (distortion correcting 1), and next an image restoring operation is performed in order to correct vibrations. Next, electronic correction is performed, the image is inversely corrected up to a level L₂, and the distortion is returned in a barrel-type direction (distortion correcting 2). Here, definitions of terms will be briefly described. The correction of the distortion indicates that the influence of the distortion is eliminated or reduced in image data influenced by the distortion. The inverse correction of the distortion indicates a process to intentionally distort the image data which does not have any distortion, or to further increase the influence of the distortion on the image data having the distortion. Here, as compared with the distortion correcting 1, a distortion amount is reduced in the distortion correcting 2 which is the inverse correction of the distortion correcting 1. Assuming that correction into the pin-cushion type is represented by plus (+), and correction into the barrel type is represented by minus (−), for example, a maximum distortion amount in the periphery of an image height d=1 is +12% in the distortion correcting 1, and −4% in the distortion correcting 2. Also with regard to the pin-cushion type distortion, similarly, image distortion (pin-cushion type distortion) L₃ by the lens is corrected into a targeted level L₀ indicating zero distortion (distortion correcting 1), and next the image restoring operation is performed in order to correct the vibrations. Next, the electronic correction is performed, and the image is inversely corrected up to the level L₂ to obtain a barrel type image.

As described above, after the distortion correcting (distortion correcting 1) targeting at the zero distortion, the inverse correction into the barrel type is performed (distortion correcting 2). Consequently, even if the pin-cushion type image is produced in the distortion correcting 1 by the fluctuation of the distortion correcting, attributed to the differences of the lens properties, the pin-cushion type image is forcibly corrected into the barrel type image by the distortion correcting 2. Therefore, the image distorted into the pin-cushion type is prevented from being produced, and the image is restored without any sense of incongruity. Even in a case where the distortion differs with each area because of a so-called straw hat type distortion which is a mixture of the pin-cushion and barrel type distortions, the image is obtained without any sense of incongruity by both of the distortion correcting into zero (distortion correcting) and the inverse correction into the barrel type (distortion correcting 2). Here, the distortion inverse correction (distortion correcting 2) is performed in the image restoring operation circuit 123, and the image restoring operation circuit 123 may be referred to as a vibration restoring unit and a distortion inverse correction unit. It is to be noted that the distortion correcting 2 of the pin-cushion type distortion is also performed in the image restoring operation circuit 123.

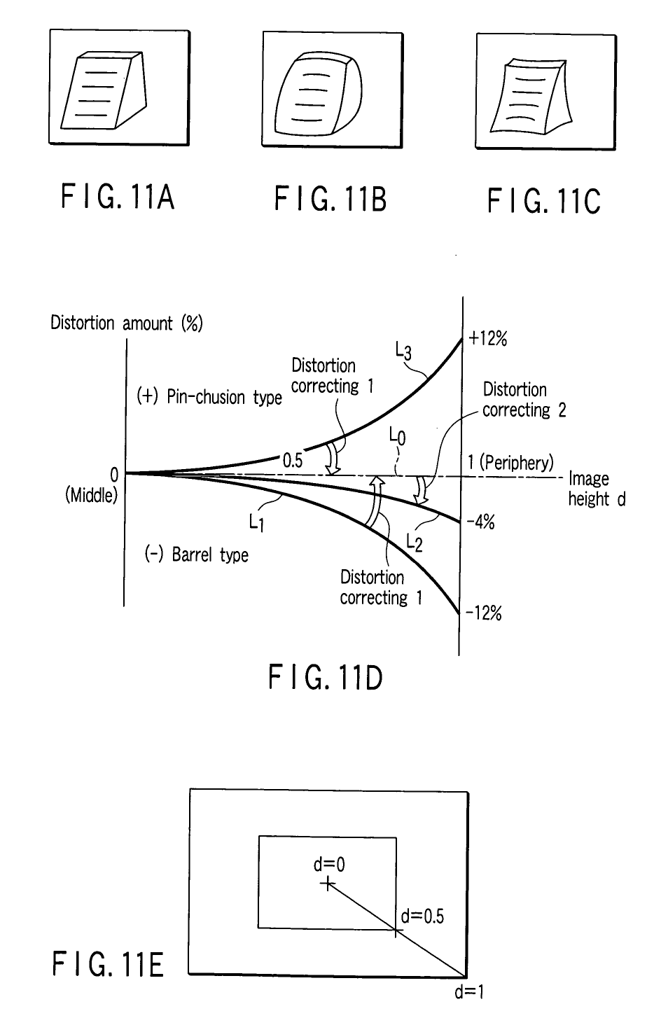

FIG. 12 shows a flowchart of a process of the sequence control circuit 119 in the image restoration of FIG. 11. FIG. 12 is different from the flowchart of FIG. 10 in that the distortion correcting 2 is added. That is, when the release switch 3 is pressed to start the image pick-up (S301), the distortion correcting value corresponding to the distortion is read from the distortion correcting value memory 171 based on the zoom position and the subject distance (S302). Next, in the image restorative function calculating circuit 122, the image restorative function is calculated from a vibration detecting signal (vibration locus) of a time series, obtained from the vibrations detected by the angular velocity sensors 108, 109 (S304). The lens image distortion (barrel type distortion L₁ or pin-cushion type distortion L₃) by the lens is corrected into the targeted level L₀ indicating the zero distortion in the image distortion correcting circuit 172 (distortion correcting 1) (S303). Subsequently, the restoring operation is performed in the image restoring operation circuit 123 (S305), and the image is inversely corrected in a direction in which the barrel type distortion is generated to obtain the level L₂ (S306). Thereafter, the image is compressed in the image compression•extension circuit 151 (S307), and the compressed image is recorded in the image recording medium 153 via the recording unit 152 (S308).

### Fourth Embodiment

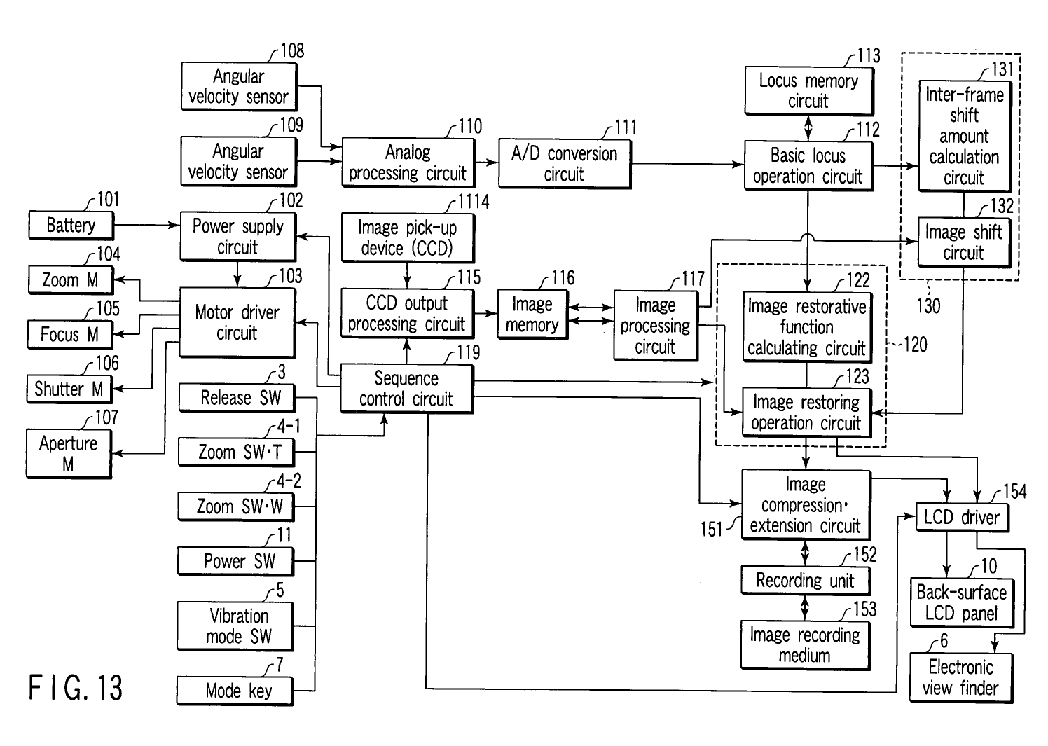

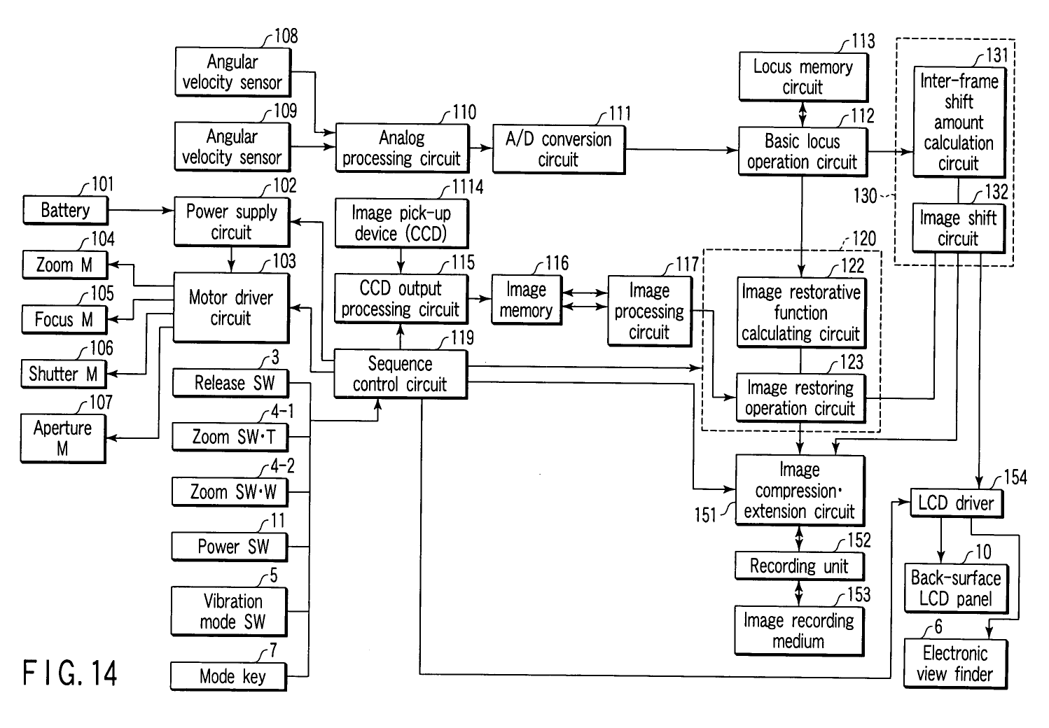

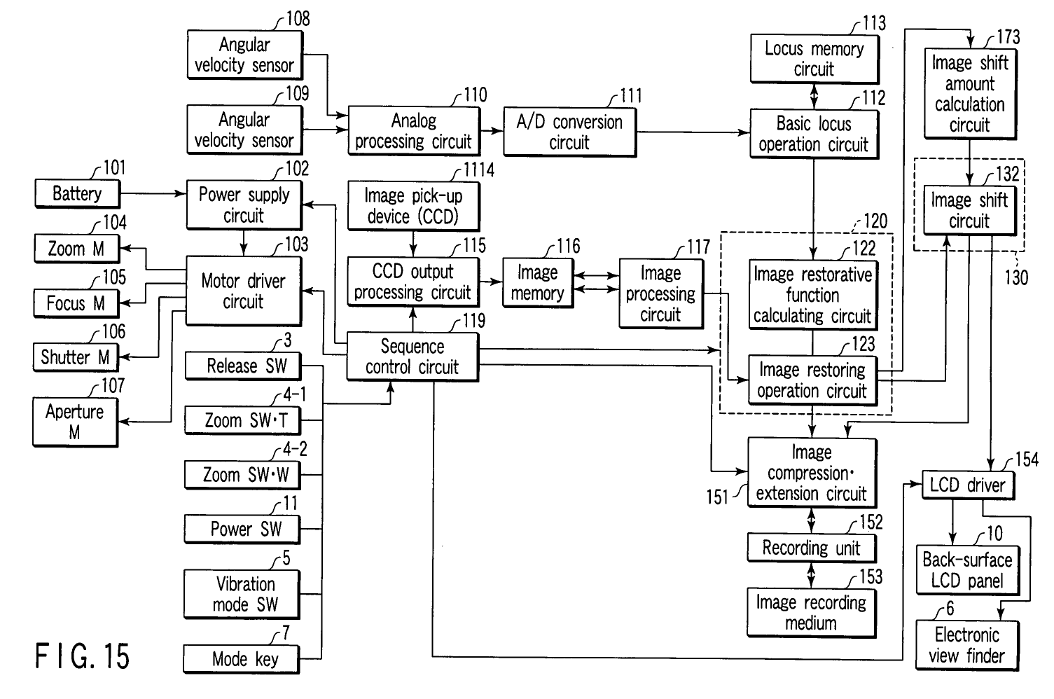

Another embodiment (fourth embodiment) will be described with reference to FIGS. 13 to 15. In the embodiment, image deteriorations by vibrations between frames in moving images are considered. In the fourth embodiment, FIGS. 1 to 8 except FIG. 3 are also applied to the fourth embodiment. Here, FIGS. 13 and 14 are block diagrams of a control circuit of a digital camera, and are different from FIG. 3 in that a correction value storage memory 118 and a locus correction circuit 121 which are constituents elements are omitted. FIG. 15 is different from FIG. 3 in that in addition to the correction value storage memory 118 and the locus correction circuit 121, an inter-frame shift amount calculation circuit 131 is omitted, and an image shift amount calculation circuit 173 is added.

Objects of FIG. 13 include a moving image and a through image. After correcting the vibrations between the frames, the vibrations in the frames are corrected. That is, in an image shift circuit 132, the vibrations are corrected for each frame in accordance with vibrations detected by angular velocity sensors 108, 109. Moreover, after processing an image based on a vibration locus with respect to each frame in an image restoring operation circuit 123, the image is displayed in a view finder 6 or a back-surface LCD panel 10, or recorded in an image recording medium 153 in the same manner as in a still image. In this constitution, the vibrations in the frames are corrected, and clear through image and moving image are obtained. In the photographing of the moving image, the vibrations in the frames are corrected in addition to the vibration correcting between the frames. Therefore, a high-quality image is obtained as compared with a case where the vibrations between the frames are only corrected. The inter-frame correction is first performed. Subsequently, after an area to be displayed as an image in actual is determined, the in-frame correction is performed. Therefore, an amount to be processed is reduced as compared with a case where a useless portion which is not used in the display is also corrected.

Moreover, a sequence control circuit 119 obtains an image shift amount generated between the frames in response to a vibration detecting signal, and operates the image shift circuit 132 in accordance with the image shift amount generated between the frames. Moreover, both of the corrections between the frames and in the frames are based on outputs of the angular velocity sensors 108, 109. Therefore, even when there is a moving subject in a screen, the shift of the frame is not influenced, and does not become incorrect, and an image of a subject which is not moving can be securely prevented from being deteriorated by the vibrations.

Objects of FIG. 14 also include a moving image and a through image. Contrary to FIG. 13, in FIG. 14, after the vibrations in the frames are corrected, the vibrations between the frames are corrected. That is, in the same manner as in the still image, after restoring the image based on the vibration locus with respect to each frame in the image restoring operation circuit 123, the vibrations are corrected for each frame in the image shift circuit 132 in accordance with the vibrations detected by the angular velocity sensors 108, 109, and the image is displayed in the view finder 6 or the back-surface LCD panel 10, or recorded in the image recording medium 153. Even in this constitution, the vibrations in the frames are corrected, and the clear through image and moving image are obtained.

Also in the fourth embodiment, after the vibrations between and in the frames are corrected, the resultant image is compressed in an image compression•extension circuit 151, and recorded in the image recording medium 153 utilizing a recording unit 152. Thereafter, after performing the vibration restoring operation, the image can be compressed and recorded, and the image restoring operation can be performed before the compression without any deterioration. Therefore, a correct vibration restoring operation can be performed. Furthermore, since the image is compressed and recorded after correcting the vibrations between and in the frames, more high-quality images can be recorded in the image recording medium 153 which has less capacity and which is small, and which is inexpensive.

FIG. 15 is the same as FIG. 14 except that the image shift amount calculation circuit 173 is disposed instead of the inter-frame shift amount calculation circuit 131. That is, in FIG. 15, in the image shift amount calculation circuit 173, an image shift amount between frames is calculated from a change of the image between the frames, for example, by a correlating operation or the like of the image, and the image is shifted. In this constitution, when the image is unclear by the vibrations between the frames, the calculation of the shift amount between the frames becomes incorrect. Therefore, it is effective to perform the vibration restoring operation in the frame before the calculation of the shift amount.

Moreover, in the photographing of the moving image, after the vibration in the frame is corrected, the image shift amount between the frames is obtained from image data based on data of the vibration correcting. Therefore, the correct shift amount between the frames can be calculated, and more correct vibration correcting is possible as compared with a case where the image shift between the frames is obtained using an image in which the vibrations between the frames are not corrected.

Here, the sequence control circuit 119 obtains the image shift amount generated between the frames from the image data, and operates the image shift circuit 132 in accordance with the image shift amount generated between the frames. Therefore, with regard to the shifting of the frame, in general, the outputs of the angular velocity sensors 108, 109 have a longer time between the frames rather in the frames, the shifting of the frame does not become incorrect by integration of noise components, and correct shifting can be performed.

Furthermore, the sequence control circuit 119 preferably executes a control in such a manner as to selectively operate both or either of the image shift amount calculation circuit 173 and the image shift circuit 132. In this case, an unnecessary portion does not have to be operated in a case where the deterioration in the frame by the vibration is small, and therefore power consumption can be reduced.

As described above, according to each embodiment of the present invention, even when the image is deteriorated by the distortion of the optical system or the like, the image deterioration generated by the optical system can be corrected before the restoration of the image deteriorated by the vibration. In the technique of each embodiment, after eliminating the influence of the image deterioration, the vibration restoring operation can be performed. The technique is applicable broadly to a field where the image deterioration by the distortion or the like needs to be eliminated to restore the image deteriorated by the vibration.

Especially, according to a first mode of the present invention, even when the image is deteriorated by the distortion of the optical system or the like, the image deterioration caused by the optical system is corrected before the restoration of the image deteriorated by the vibration. Accordingly, after eliminating the influence of the image deterioration, the vibration restoring operation can be performed. Consequently, the accurate restoration of the image deteriorated by the vibration can be performed over the whole screen by a simple operation, and a sharp image can be obtained in the whole screen.

Moreover, according to a second mode of the present invention, the sharp image in the whole screen can be recorded in the recording medium.

Furthermore, according to a third mode of the present invention, even when the image is deteriorated by the aberration of the photographing lens or the like in the optical system, the image deterioration caused by the optical system can be corrected before the vibration restoring operation. Accordingly, after eliminating the influence of the image deterioration, the vibration restoring operation can be performed, and the accurate restoration of the image deteriorated by the vibration can be performed over the whole screen by the simple operation. Furthermore, after the vibration restoring operation is performed, the image is compressed and recorded. Therefore, the image restoring operation can be performed in a state in which there is a large amount of data before compressed, and the accurate vibration restoring operation can be performed. Thereafter, the image can be compressed and recorded, and therefore more images can be recorded even in a recording medium which has less capacity and which is small and inexpensive.

Additionally, according to a fourth mode of the present invention, the accurate vibration restoring operation can be performed regardless of the aberration of the lens, and a sharper image can be obtained in the whole screen.

Moreover, according to a fifth mode of the present invention, even when the image is influenced and deteriorated by the distortion of the optical system, and the locus of the image movement changes for each area irrespective of the same vibration, because of compression, enlargement, direction change or the like, the distortion is corrected before the vibration restoring operation. Accordingly, after the influence of the image deterioration is eliminated, the vibration restoring operation can be performed. Consequently, the vibration locus information or the function for the restoring operation does not have to be corrected for each image area, the accurate restoration of the image deteriorated by the vibration can be performed over the whole screen by a simple operation, and the sharp image can be obtained in the whole screen.

Furthermore, according to a sixth mode of the present invention, the influence of shading, which has a large influence on the vibration restoring operation, can be eliminated to correct the image deterioration, and the sharp image can be obtained in the whole screen with less data capacity.

Additionally, according to a seventh mode of the present invention, the influence of the distortion, which has a large influence on the vibration restoring operation, can be eliminated to correct the image deterioration, and the sharp image can be obtained in the whole screen with less data capacity. Furthermore, even in a case where there is an error in the correction of the distortion because of manufacturing fluctuations of lenses, and the distortion is corrected to reach zero, but there is a possibility that the pin-cushion type distortion is generated to a certain degree because of the fluctuations, the distortion is corrected in a direction in which the barrel type distortion results after the vibration restoring operation. This can prevent the pin-cushion type distortion which seems to be unnatural for people senses, and there can be obtained an image pick-up apparatus in which the image is sharp without generating any unnatural distortion over the whole screen.

Moreover, according to an eighth mode of the present invention, an excessive barrel type distortion can be prevented by inverse correction, and the unnatural image can be prevented from being generated.

Furthermore, according to a ninth mode of the present invention, even when the image is deteriorated by the distortion of the optical system, the image deterioration generated by the optical system is corrected before the restoration of the image deteriorated by the vibration. Accordingly, after the influence of the image deterioration is eliminated, the vibration restoring operation can be performed. Consequently, the accurate restoration of the image deteriorated by the vibration can be performed over the whole screen by the simple operation, and the sharp image can be obtained in the whole screen.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general invention concept as defined by the appended claims and their equivalents.

What is claimed is:

1. An image pick-up apparatus comprising:
an optical system which forms a subject image;
an image pick-up unit which obtains image data from the subject image formed by the optical system;
a vibration detecting unit which detects a vibration of the image pick-up apparatus;
a vibration detecting signal storage unit which stores a vibration detecting signal of a time series output from the vibration detecting unit during an exposure of the image pick-up unit;
an image deterioration information storage unit in which information of image deterioration generated by the optical system is stored;
an image deterioration correcting unit which corrects the image deterioration generated by the optical system with respect to the image data output from the image pick-up unit in accordance with the image deterioration information stored in the image deterioration information storage unit; and
a vibration restoring unit which restores the image deteriorated by the vibration with respect to the image data output from the image deterioration correcting unit in accordance with the vibration detecting signal of the time series stored in the vibration detecting signal storage unit.

2. The image pick-up apparatus according to claim 1, further comprising:
a recording medium in which the image data output from the vibration restoring unit is recorded; and
a recording unit which records the image data output from the vibration restoring unit in the recording medium.

3. An image pick-up apparatus comprising:
an optical system which forms a subject image;
an image pick-up unit which obtains image data from the subject image formed by the optical system;
a vibration detecting unit which detects a vibration of the image pick-up apparatus;
a vibration detecting signal storage unit which stores a vibration detecting signal of a time series output from the vibration detecting unit during an exposure of the image pick-up unit;
an image deterioration information storage unit in which information of image deterioration generated by the optical system is stored;
an image deterioration correcting unit which corrects the image deterioration generated by the optical system with respect to the image data output from the image pick-up unit in accordance with the image deterioration information stored in the image deterioration information storage unit;
a vibration restoring unit which restores the image deteriorated by the vibration with respect to the image data output from the image deterioration correcting unit in accordance with the vibration detecting signal of the time series stored in the vibration detecting signal storage unit;
a compression unit which compresses the image data output from the vibration restoring unit; and
a recording unit which records the image data output from the compression unit in a recording medium.

4. The image pick-up apparatus according to claim 1, wherein the image deterioration information includes information relating to an aberration of the optical system.

5. The image pick-up apparatus according to claim 2, wherein the image deterioration information includes information relating to an aberration of the optical system.

6. The image pick-up apparatus according to claim 4, wherein the aberration of the optical system is a distortion.

7. The image pick-up apparatus according to claim 5, wherein the aberration of the optical system is a distortion.

8. The image pick-up apparatus according to claim 1, wherein the image deterioration information includes information relating to shading.

9. The image pick-up apparatus according to claim 3, wherein the image deterioration information includes information relating to shading.

10. An image pick-up apparatus comprising:
an optical system which forms a subject image;
an image pick-up unit which obtains image data from the subject image formed by the optical system;
a vibration detecting unit which detects a vibration of the image pick-up apparatus;
a vibration detecting signal storage unit which stores a vibration detecting signal of a time series output from the vibration detecting unit during an exposure of the image pick-up unit;
a distortion information storage unit in which information relating to a distortion generated by the optical system is stored;
a distortion correcting unit which corrects the distortion generated by the optical system with respect to the image data output from the image pick-up unit in accordance with the information relating to the distortion stored in the distortion information storage unit;
a vibration restoring unit which restores the image deteriorated by the vibration with respect to the image data output from the distortion correcting unit in accordance with the vibration detecting signal of the time series stored in the vibration detecting signal storage unit;
a distortion inverse correction unit which inversely corrects the distortion by a predetermined amount in a barrel-type direction with respect to the image data output from the vibration restoring unit; and
a recording unit which records the image data output from the distortion inverse correction unit in a recording medium.

11. The image pick-up apparatus according to claim 10, wherein the distortion inverse correction unit inversely corrects the distortion at a small ratio to the correction of the distortion.

12. An image restoration method comprising:
obtaining image data by photographing;
detecting a vibration at a time of the photographing;
correcting the image data obtained by the photographing based on image deterioration information of an optical system; and
restoring the corrected image data, which is deteriorated by the vibration, based on the vibration.
